(19) United States
(12) Patent Application Publication
(10) Pub. No.: US 2017/0228759 A1
(43) Pub. Date: Aug. 10, 2017

(54) Mall Media Coupon Kiosk

(71) Applicants: Donald A. Haese, Fort Lauderdale, FL (US); Ralph E. Clements, Houston, TX (US)

(72) Inventors: Donald A. Haese, Fort Lauderdale, FL (US); Ralph E. Clements, Houston, TX (US)

(21) Appl. No.: 14/833,925

(22) Filed: Aug. 24, 2015

Related U.S. Application Data
(60) Provisional application No. 62/041,636, filed on Aug. 25, 2014.

(51) Int. Cl. G06Q 30/02; G07F 19/00; G07F 17/28; G07F 17/16

(52) U.S. Cl. CPC G06Q 30/0237; G06Q 30/0268; G07F 17/16; G07F 19/203; G07F 17/28

(57) ABSTRACT

A self-service automated coupon kiosk system may be located at entrances to malls or other commercial establishments. It may be used at the entrance to specific retailers in the mall to draw attention to offers of the specific retailer. The system is ideally designed to be employed in high traffic areas or zones. The kiosk is designed to continuously deliver fresh, rotating coupons, special offers and video and messages to attract shoppers as the enter the mall, such coupons being specifically directed to retailers in the mall. In addition, the system may also be used as an ATM location. The unit can also serve as a marketing channel for the mall itself or for specific retailers. A high capacity plastic gift card printer may also be incorporated into the unit. Any combination from one to all of these features may be used depending upon the application.

### CROSS REFERENCE TO RELATED APPLICATION

This application is a completion of the Provisional Application No. 62/041,636 filed on Aug. 25, 2014 and claims priority based on that application.

### BACKGROUND

The subject invention is directed to a self-service automated coupon kiosk system which may be located at entrances to malls or other commercial establishment It may be used at the entrance to specific retailers in the mall to draw attention to offers of the specific retailer.

The system is ideally designed to be employed in high traffic areas or zones. For example, the unit The kiosk is designed to continuously deliver fresh, rotating coupons, special offers and video and messages to attract shoppers as the enter the mall, such coupons being specifically directed to retailers in the mall.

In addition, the system may also be used as an ATM location. The unit can also serve as a marketing channel for the mall itself or for specific retailers. A high capacity plastic gift card printer may also be incorporated into the unit. Any combination from one to all of these features may be used depending upon the application.

The kiosk system of the subject invention provides mall marketers and advertisers with new and useful marketing tools. Coupons, ad messages and video presentations are delivered in an integrated kiosk directed specifically toward visitors of the mall at the specific time they enter the mall to shop.

### BRIEF DESCRIPTION OF THE DRAWINGS

FIG. 1 is a perspective view of a kiosk with a coupon delivery system in accordance with the invention.

FIG. 2 is a flow diagram of the management software for the system.

FIG. 3 is a perspective view of a kiosk with additional advertising functions and/or an integrated ATM machine and gift card delivery system.

### DESCRIPTION

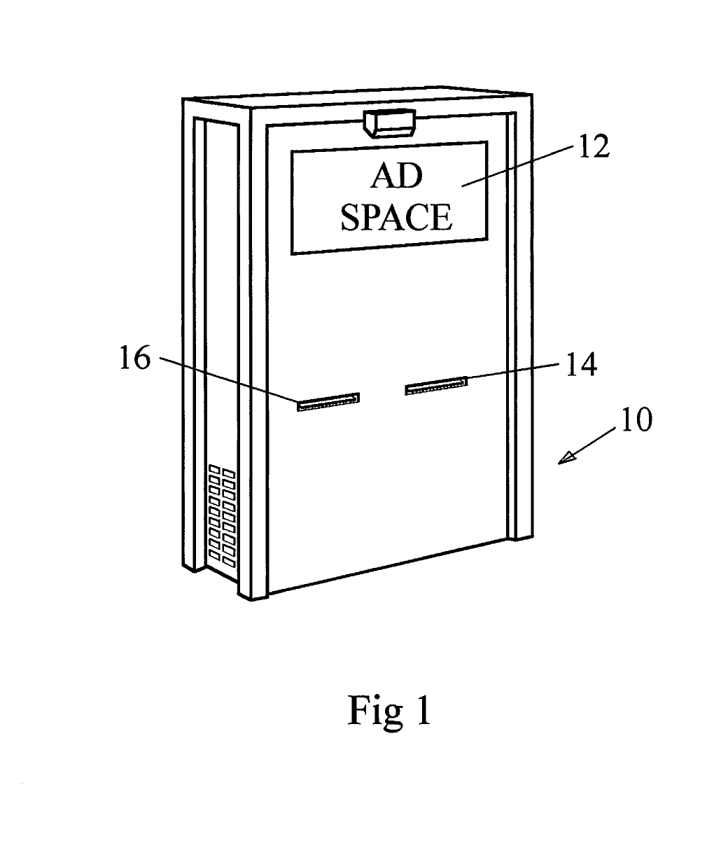

As shown in FIG. 1 the kiosk is a stand alone unit 10 having a display screen 12 for displaying video messages and ads. A dispenser slot 14 is provided for dispensing coupons. A second dispenser slot may be used for dispensing written or graphic information relating to the ads or messages.

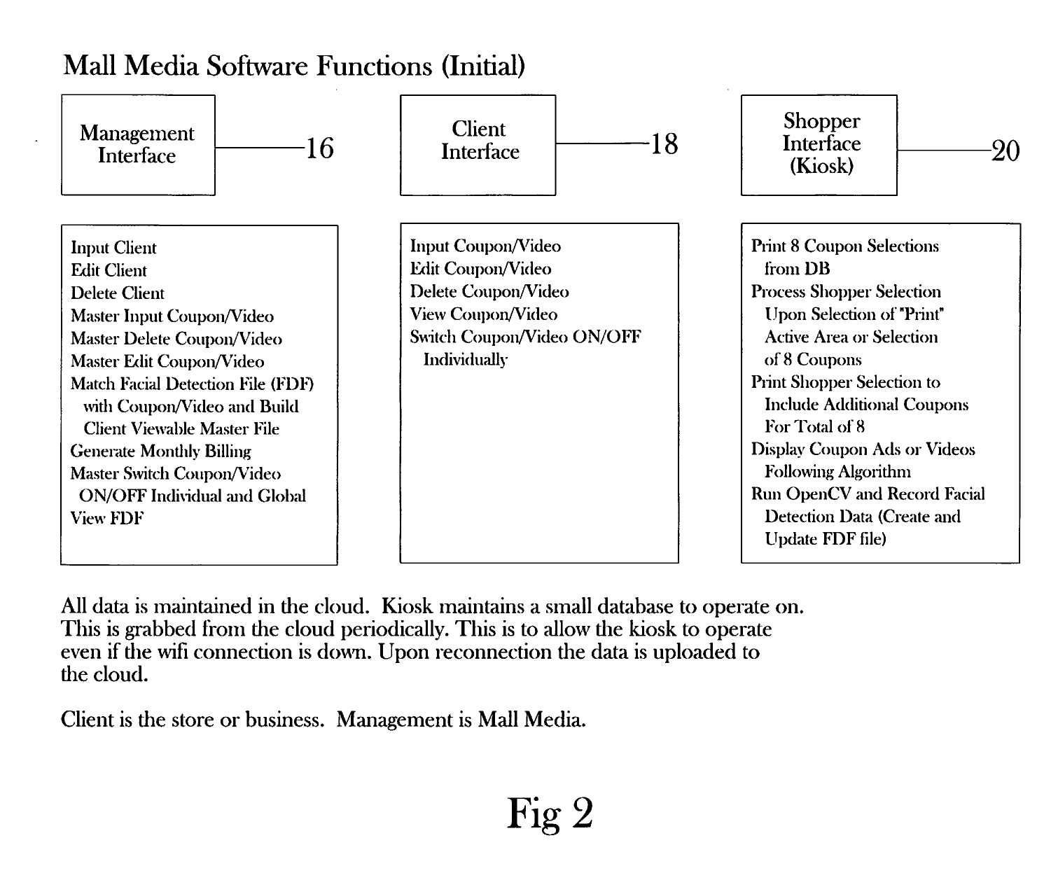

FIG. 2 shows the functions of the management interface 16, the client (retailer) interface 18 and the shopper of user interface 20. As indicated at management interface 16, remote management of the kiosk permits: client input and editing, including deletion; input, editing and deletion of coupons, messages and video. Recognition software may also be provided, including, but not limited to facial recognition. The system is designed to produce and deliver monthly billing to the client/retailer.

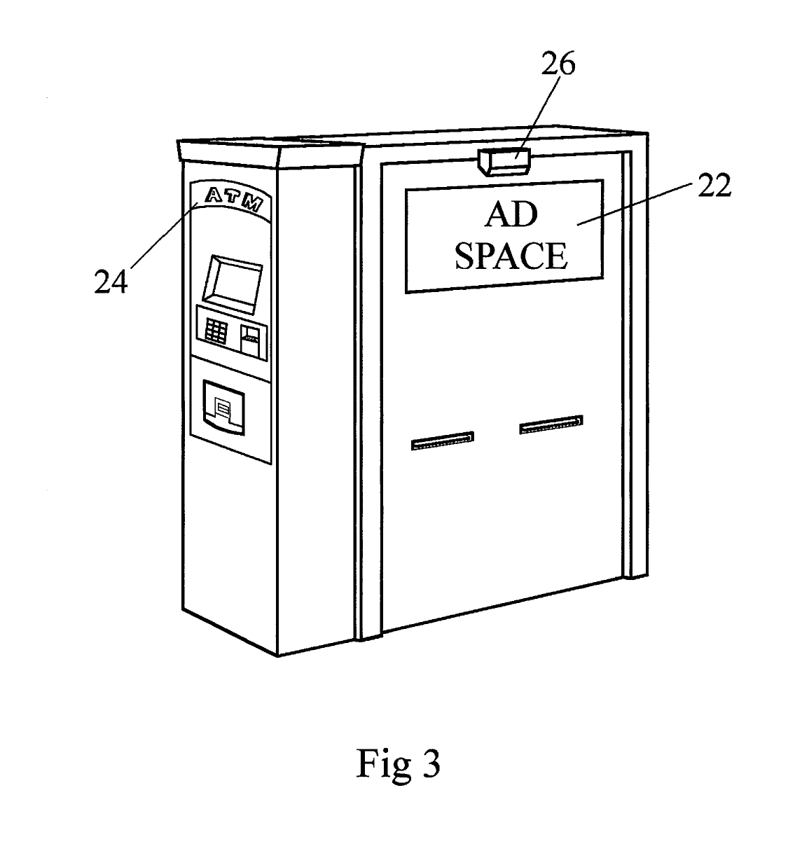

FIG. 3 shows a kiosk with additional advertising modules such as the video screen 22, the ATM module 24, which can also be configured as a gift card dispenser. This may also include audio, as is typical.

The client interface 18 permits input or loading of coupons and/or video, including editing and deletion functions. Individual coupons and/or videos may be activated or deactivated.

The kiosk provides the shopper interface 20. The number of coupons to be printed may viewed and selected from the database.

The technology supports the delivery of both paper and electronic coupons and is compatible with smart phones for loading the coupons directly on the cell phone device. This permits seamless delivery of almost instantaneous offers from a retailer to a shopper on a continuous basis.

The coupon delivery system is the main product of invention, as indicated at 14 and 16. This is a multi-platform media console designed specifically to accommodate a 3-way partnership in profit between a major mall, its resident mall merchant advertisers.

In the most basic terms, The unit allows mall merchants to distribute their coupon offers to their most qualified market segment (those consumers physically walking into the mall) in a fast, efficient and economical way. The unit is strategically located in high traffic choke points in mall entrances with a large video display 22 that attracts consumers and distributes coupons from retailers inside the mall.

In addition, can also double as an ATM location as indicated at 24. Due to the design of the unit, an ATM module can be attached to add an additional service to consumers as they enter the mall.

### Benefits and Features

EASE OF USE—Coupons are submitted by the merchant through a simple online account interface 18, see FIG. 2, to the system with user-driven and user-friendly software where advertisers can enter their existing in-store coupons into available coupon slots, or they can choose from coupon templates offered in the software.

EFFICIENT—Merchants have flexibility to remotely control amount, terms or expiration dates, run daily or hourly specials or blowouts, immediately cancel coupons on sold-out merchandise, instantly sweeten the offer if the coupon is not performing and quickly turn overstocks or closeouts into cash. The merchant receives fast marketing feedback to quickly test offers or campaigns.

ECONOMICAL—Merchants pay only for actual coupons-in-hand and actual counted impressions disseminated to their best prospective customers. With the system of the subject invention, 100% of coupon ads are delivered “in hand” every time, guaranteeing that merchant advertisers get what they pay for with video proof available.

Most ad media charge impression rates based on the number of people who could “potentially” see your ad, not by the actual number that were within a measured distance from the screen when their video ad plays.

### Operating System

Shoppers pull coupons from delivery slot(s) 14, 16 as they enter the mall and are also counted as impressions for the advertiser whose video ad is playing on the screen 22 as they are present in the viewing cone of the screen. Their presence in the mall defines them as being in a buying frame of mind and makes them more likely to act on a store's offer.

Shoppers will also be attracted to the unit's ATM machine 24 for cash and other banking services.

The unit is fully self-sufficient outside of minor regular maintenance and requires no retail employees. The consumer experiences a seamless transition from parking their car outside the mall, seeing the retailer's ad pulling coupon sheets from delivery slots 14, 16, and entering the mall to shop. Specialized software allows the advertisers to easily upload their video impressions and coupons.

### Advantages Over Existing Ad Options

The unit neutralizes the disadvantages of common coupon delivery vehicles/systems, which are:
Distance from merchant when delivered
Unchangeable offers with long lead times to test and change the terms or the offer
Exposure to numerous distractions on the way to buying coupon item
Coupons get stale quickly
Coupons “die” in handbags and pockets and eventually get thrown away

Merchant tenants get the ability to micro-target their advertising allowing them to increase the effectiveness of their advertising dollar and more efficiently raise their sales. With the model, merchants can deliver offers when:
Shopper is no further than a few hundred feet from the store
Shopper, by definition by being at the mall, are in a shopping frame of mind.

Advertisers can create urgency with close-in expiration dates (fear of loss will tend to make it difficult for some shoppers to leave the mall knowing that a valuable coupon in their possession will expire in a few hours), Instantly sweeten the offer if the coupon is not performing, offer the retailer prompt measurability and feedback, provide “fresh” coupons which has not been in the possession of the consumer in the mall long enough to be forgotten, lost or thrown away.

The system capitalizes on the principal of instant gratification. Discounts “cost” the retailer nothing as the only out-of-pocket expense is coupon distribution cost.

In the preferred embodiment of the invention the unit doubles as an ATM location to help in attracting consumers to the unit.

Coupons are guaranteed to be “eyeballs-on-ads” or “ads-in-hand” and impressions are guaranteed making for efficient use of an advertiser's marketing dollars. The Company's systems will allow advertisers to more clearly see their actual cost, compelling other in-mall media to abandon ambiguous pricing and vague traffic estimates. This should lead to more in-mall media competition leading to lower prices for advertisers.

The system creates a broader, timelier, more convenient and simple way distributing money-saving coupons, ad messages and impressions allowing consumers to be exposed to many more savings opportunities.

The system may include video cameras 26 (FIG. 3) that verify the delivery of a coupon to a shopper. This gives coupon advertisers video verification that the sheet that contains their coupon was actually delivered. This also permits the advertiser to count people to satisfy and fulfill the impressions side of the units:

Most malls use “ESTIMATES” to determine their annual traffic number. Our system will count all of the people who walk by our unit(s) within a pre-defined cone of detection. This information based on actual count can be invaluable to both the private and the public sector in determining shopping behavior and effectiveness of advertising.

A number of coupon slots may be set aside for public service announcements, security announcements, amber alerts, etc. Similarly, a number of video ad time slots may also be set aside for public announcements, security announcements, amber alerts. In an emergency (lost child, fire, etc.) both the outputs in all units in a mall can immediately be switched to address the emergency and disburse information about it to shoppers in the mall.

Physically, the unit includes two output components, 1) printers to issue coupons at slots 14, 16, and 2) monitors to accommodate coupon search. The monitors can deliver ad messages to shoppers within 6-8 feet of the audio visual message playing on the screen. This builds revenue from the impressions that are created, priced and sold in much the same way as cable TV does, with one major difference.

The units also have a video camera on both sides which, with the addition of an off-the-shelf software module for each camera, can be made to accurately count every person that walks by the unit on either side, coming or going.

If a merchant's ad of any length plays to a steady but erratic flow of foot traffic, the unit can accurately count the number of people walking by while it was playing (creating impressions) and charge accordingly. The technology in certain software also has an anonymity feature that can block faces for usage in those states where videotaping laws require it.

The combination of harvesting millions of impressions from mall visitors and offering advertisers an accurate count as to exactly how many impressions they are getting while the screen plays their ad is a unique, one-of-a-kind ad medium that could easily make other media in the mall relatively less attractive.

In addition, combination packages permits an advertiser to use a broadcast on the monitor to promote taking a coupon that they have in the coupon rotation or in their library by simply pushing a button on the touch screen while it is playing. This creates a unique and very attractive 1-2 punch marketing method.

The third revenue stream comes from the modular nature of the unit. By adding an ATM 24 to the unit.

The revenue stream also comes from the modularity of the unit and allows us to add gift a gift card exchange in combination with or at the opposite end of the ATM module and similarly shaped. A selection of off-the-shelf software is available in the gift card exchange category and we are in the process of evaluating them now. The way these work is that remaining balances on old cards are exchanged, at varying rates of discount depending on the brand, for a new card of a brand of their choice with a balance equal to the credit accrued from their exchanging the old gift cards.

These systems require a CPU, a touch-screen monitor, a card value reader and a printer (pictured as a printer slot on the face of the end cap), all off-the-shelf. The gift card can be an e-card, similar to an airline e-ticket, where the confirmation of value is represented by a bar code, either printed or stored on a smart phone. The system is designed to deliver both. By paper, we will print out a bar code for the new card and offer an electronic transfer of the code to a phone as well, consumer's choice.

Not all ad impressions will always be sold, leaving the unit with extra available ad run times. These may be offered to the mall partner free of charge or at a reduced rate as a unique value proposition that will help secure the partnership.

The target market is major retailer's regional marketing managers. This audience is a small, identifiable group of prospects which should prove to be relatively simple to reach. Media that is suited for drawing broad audiences can deliver “waste” —diluting marketing efforts and ultimately delivering a less cost-efficient plan.

While certain advantages and features of the invention have been described in detail herein, is should be understood that the invention includes all modifications and enhancements within the scope and spirit of the following claims.

What is claimed is:

1. A kiosk system for delivering data and physical materials to a user, comprising:
a. A coupon delivery module adapted for delivering a paper coupon to the user;
b. An advertising module for advertising data to be delivered to the user.

2. The kiosk system of claim 1, wherein the advertising module is a video screen.

3. The kiosk system of claim 1, wherein the advertising module includes audio.

4. The kiosk system of claim 1, further including an ATM module.

5. The kiosk system of claim 1, further including a gift card dispenser.

6. The kiosk system of claim 1, wherein the coupon may be delivered as an electronic data stream for a smart phone on the like.

7. The kiosk system of claim 5, wherein the gift card may be delivered as an electronic data stream for a smart phone on the like.
